(19) United States
(12) Patent Application Publication
(10) Pub. No.: US 2006/0095355 A1
(43) Pub. Date: May 4, 2006

(54) Method of securitizing a pool of net lease assets of financial institutions cross reference to related applications

(75) Inventors: Matthew R. Mayers, Armonk, NY (US); David N. Rosenwaks, New York, NY (US); Joshua S. Siegel, New York, NY (US)

Correspondence Address: KATTEN MUCHIN ROSENMAN LLP, 525 WEST MONROE STREET, CHICAGO, IL, 60661-3693, US

(73) Assignee: StoneCastle Partners, LLC

(21) Appl. No.: 11/165,687

(22) Filed: Jun. 24, 2005

Related U.S. Application Data
(60) Provisional application No. 60/623,183, filed on Oct. 29, 2004.

(51) Int. Cl. G06Q 40/00

(52) U.S. Cl. 705/35; 705/42

(57) ABSTRACT

A financial securitization transaction, such as a collateralized debt obligation (CDO) transaction, that (i) is at least partially collateralized by a plurality of net lease assets where the tenants to the leases are financial institutions generally with assets of less than $10 billion, and (ii) where such securitization may not be fully collateralized by such net lease assets, in which case the remainder of the collateral for such securitization may consist predominantly of obligations (including trust preferred securities, debt and/or surplus notes) of financial institutions, and/or traunches of CDOs backed predominantly by such obligations. By restricting the assets to net lease assets in which the tenants are financial institutions and restricting the remaining assets to predominately obligations of financial institutions or tranches of CDOs backed by such obligations, more favorable ratings are obtainable from the ratings agencies for the securities backed by the net lease assets. In accordance with an important aspect of the present invention, the ratings of the debt securities of the securitization rely on the aggregate pooled credit quality of the multiple financial institutions backing the various net lease assets and the geographic diversity of such financial institutions, instead of on the explicit investment ratings of any one of the individual obligors in the pool. In accordance with another important aspect of the present invention, as opposed to the typical 5%-10% recovery rate assumed for traditional financial institution collateral used in pooled financial institution obligation CDO transactions, the net lease assets are collateralized by property, which translates into a materially higher assumed recovery rate, for example, in excess of 40%. Through the mechanism of the balloon payment provider (which is also an important aspect of the present invention), the net lease assets do not require residual value insurance and the need for equity capital is significantly reduced or even eliminated.

### CROSS REFERENCE TO RELATED APPLICATIONS

This application claims the benefit of U.S. patent application No. 60/623,183, filed on Oct. 29, 2004, hereby incorporated by reference.

### BACKGROUND OF THE INVENTION

1. Field of the Invention

The present invention relates to a method of securitizing a plurality of net lease assets where the tenants to the leases are financial institutions that generally have assets of less than $10 billion or do not have explicit public ratings. In accordance with an important aspect of the present invention, the ratings of the debt securities of the securitization rely on the aggregate pooled credit quality of the multiple financial institutions backing the various net lease assets and the geographic diversity of such financial institutions, instead of on the explicit investment ratings of any one of the individual obligors in the pool.

2. Description of the Prior Art

Securitization is a structured process of packaging various assets including interests in various receivables, fixed income securities, loans, mortgages, lease payments or other receivables or financial obligations, and underwriting these assets with asset-backed securities. This process is known to be used to convert such assets into cash. For example, U.S. Pat. No. 6,654,727 relates to a method of securitizing a portfolio of at least 30% distressed loans. U.S. Pat. No. 6,622,129 relates to securitizing another type of asset, namely vehicle leases. US Patent Application Publication US 2004/0199440 A1 relates to a system for the sale and lease back of assets held by the US Government to private entities.

Asset securitization is also known to be used with real estate assets. For example, US Patent Application No. US 2005/0010517 A1 discloses a method of financing tenant improvements in leased real estate. Real estate securitizations are also known that are partially or fully collateralized by so called net lease assets. Under a net lease, a tenant occupying the leased property (usually as a single tenant) does so in much the same manner as if the tenant were the owner of the property. In addition to being responsible for paying its rent to the property owner, the tenant is also responsible for the operation of the property, including payment of taxes and insurance and routine maintenance. The property owner receives the rent “net” of these expenses (i.e., these expenses have already been paid by the tenant), rendering the cash flow associated with the lease predictable for the term of the lease and unencumbered by expenses. Under such a net lease, the tenant generally agrees to lease the property for a lengthy term (typically ranging from 10 to 30 years) and agrees that it will have either no ability or only limited ability to terminate the lease or abate rent prior to the expiration of the term of the lease as a result of real estate driven events such as casualty or failure by the landlord to fulfill its obligations under the lease. Often, the lease may be a “bond style” or “bondable” lease in which the tenant's obligation to pay rent is not excused or reduced for any reason including the complete destruction or condemnation of the leased premises. The holder of a net lease owns an instrument similar in risk profile to a corporate bond or loan issued by the tenant. In many cases, the property is acquired in a sale-lease back transaction, where the property owner purchases the property and leases it back to the seller on a net lease basis.

In a typical net lease transaction, a trust or other special purpose entity (a “lease trust”) is formed for the sole purpose of purchasing the property and leasing the property to the tenant. In a sale-lease back, the seller of the property and the lessee are the same entity. The purchaser finances the purchase of the property by issuing one or more tranches of debt securities and a single equity tranche. The debt securities are not necessary pooled and securitized. However, when they are pooled with other similar debt securities and with other more traditional real estate debt, the securitizations take the form of, and are generally known as, commercial mortgage-backed securities (“CMBS”). When such debt securities are pooled with various rated tranches of CMBS and with other Asset Backed Securities (ABS), the securitizations take the form of, and are generally known as, collateralized debt obligation (CDO) transactions. The ability of a CDO that includes net lease assets as collateral to obtain the favorable ratings on its debt securities (and therefore lower financing costs) depends upon, among other things, the public credit rating of each obligor to the net leases (i.e. credit tenants) and the diversification among all obligors. No CDO transactions are known where the assets consist predominantly of a pool of net lease assets where the tenants to the leases are predominantly banks, thrifts, credit unions, insurance companies or other similar financial institutions, or holding companies thereof, that generally have less than 10 billion in assets or are not publicly rated or where the ratings of the debt securities issued by the CDO rely on the aggregate pooled credit quality of financial institutions backing net lease assets and the geographic diversity of those financial institutions.

CDO transactions are known where the assets consist of a pool of (i) trust preferred securities (also known as capital securities), (ii) subordinated debt, and/or (iii) in the case of insurance companies, surplus notes, in each case issued by twenty or more geographically diversified banks, thrifts, credit unions, insurance companies or other similar financials institutions, or holding companies thereof (such securities set forth in (i), (ii) and (iii) are referred to herein as “traditional financial institution collateral”). These CDO transactions (which are referred to herein as “pooled financial institution obligation CDO transactions”) may also have collateral that includes tranches of CDOs backed by traditional financial institution collateral. As used herein, “financial institution” refers to both rated and unrated financial entities, such as banks, thrift institutions, credit unions, insurance companies or other similar financial institutions, or holding companies thereof. These pooled financial institution obligation CDO transactions rely on, among other things, (i) the low cumulative default experience of such financial institutions and (ii) the geographic diversity of the issuing financial institutions in order to obtain favorable ratings from rating agencies, such as, Moody's Investors Service (“Moody's”), Standard & Poor's (“S&P”), Fitch Ratings (“Fitch”), and A.M. Best (collectively, where applicable, referred herein as “rating agencies”) on the debt securities issued by the CDO used to finance the purchase of the collateral.

In conjunction with their rating the current pooled financial institution obligation CDO transactions, all three rating agencies assess the credit quality of each obligor, but solely for the purpose of including such obligor in a pooled financial institution obligation CDO transaction. The factors considered include, but are not limited to: relative capital strength, earnings, liquidity, asset quality, operating history, bank size and concentration in commercial real estate assets. When a financial institution has existing explicit ratings on either the financial institution or a security issued by a financial institution, such rating may or may not be considered when assessing the credit quality of the financial institution as part of a pooled financial institution obligation CDO. An explicit public rating from a rating agency considers many extraneous factors, from perceived corporate stability, rating agency politics related to their relationship to a financial institution, an expectation of future performance of a financial institution and a relative measure to comparable financial institutions. A credit score from a rating agency used for purposes of a pooled financial institution obligation CDO transaction, is a non-public corporate credit quality estimate that reflects the default probability of an institution at a point in time, rather than for a longer period of time (in the case of an explicit rating), and as a result such a credit score can differ significantly from an explicit public rating, even in the case where the financial institution has both a credit score and a explicit rating.

The credit information for each obligor included in a pooled financial institution obligation CDO is used by each rating agency as follows:

Moody's: The information is fed into the Moody's KMV Financial Institutions scoring model to arrive at a probability of default score for each financial institution. This score is not a rating and does not equate to an explicit public rating and can not be disclosed to the public. As an example, the explicit rating of a financial institution may differ substantially from the output of the KMV scoring model, inferring substantially different results. The average of all scores of the financial institutions in a pool is calculated into a pool-wide weighted average rating factor probability of default (“rating factor”) or weighted average default rate. A recovery rate and lag in recovery is assumed, with different default timings considered. Next, the Moody's Diversity Score Methodology is used, whereby the US is divided into at least five geographic regions, further split into 2 baskets per region and a “national” region for financial institutions that operate nationally. A more diverse pool will yield a lower expected loss on a given liability tranche after stressing for the desired rating of such trance.

Fitch: The information is inputted into Fitch's US Bank Scoring Model to arrive at a non-public score for each financial institution. This score is not a rating and does not equate to an explicit public rating and can not be disclosed to the public. The average of all scores of the financial institutions in a pool is calculated into pool-wide weighted average default score, which corresponds to a pool-wide default rate given the desired liability rating. A recovery rate and lag in recovery is assumed, with different default timings considered. Next, the geographic diversity of the pool is assessed using the aforementioned five geographic regions and one “national” region for financial institutions that operate nationally. Penalties are assigned to the weighted average default rate for over concentrations in any of the six regions.

S&P: The information is analyzed by S&P's Financial Institutions Group to arrive at rating inputs for the S&P's CDO Evaluator, which is used to generate scenario-based default rates for the portfolio at each relevant rating level. A recovery rate and lag in recovery is assumed, with different default timings considered. Geographic diversity is considered on a pool-by-pool basis.

Other pool factors, such as single obligor concentration, are considered during the rating process. E.g., if a single obligor represents greater than 5% of the pool, then the ratings for such pooled financial institution obligation CDO transaction are adversely affect, sometimes substantially so.

A securitization transaction is known where the collateral consists of a single mortgage loan secured by cross-collateralized, cross-defaulted first mortgages on the mortgagor's interests in 211 retail bank branches, offices and bank operations centers located in 26 states (the “Portfolio”), together with certain other assets. Bank of America, N.A., which has an explicit public rating of Aa2 by Moody's and A− by both Fitch and S&P, has a master lease for 71% of the square footage of the Portfolio. Bank of America has over $574 billion is domestic deposits and over $1.1 trillion of total assets. The ratings of this securitization transaction depend primarily on the explicit public ratings of Bank of America as the obligor on the master lease.

No pooled financial institution obligation CDO is known that includes a plurality of net lease assets where the tenants to the lease are financial institutions.

### SUMMARY OF THE INVENTION

Briefly, the present invention relates to a financial securitization transaction, such as a collateralized debt obligation (CDO) transaction (referred to herein as a “net lease CDO”), that (i) is at least partially collateralized by a plurality of net lease assets where the tenants to the leases are financial institutions generally with assets of less than $10 billion, and (ii) where such securitization may not be fully collateralized by such net lease assets, in which case the remainder of the collateral for such securitization consists predominantly of traditional financial institution collateral (including trust preferred securities and debt and/or surplus notes) and/or tranches of CDOs backed predominantly by such collateral. This securitization transaction in accordance with the present invention is materially different than the Bank of America transaction described above which relies primarily on the explicit public investment grade ratings of a single financial institution obligor, i.e. Bank of America, that has assets of greater than $10 billion. Rather, in accordance with an important aspect of the present invention, the ratings of the debt securities of the securitization rely on the aggregate pooled credit quality of the multiple financial institutions backing the various net lease assets and the geographic diversity of such financial institutions, instead of on the explicit investment ratings of any one of the individual obligors in the pool. In accordance with another important aspect of the present invention, as opposed to the typical 5%-10% recovery rate assumed for traditional financial institution collateral used in pooled financial institution obligation CDO transactions, the net lease assets are collateralized by property, which translates into a materially higher assumed recovery rate, for example, in excess of 40%. In accordance with another aspect of the invention, since a balloon payment provider mechanism is used, the net lease assets do not require any residual value insurance and the need for equity capital is significantly reduced or even eliminated.

### DESCRIPTION OF THE DRAWING

These and other advantages of the present invention will be readily understood with reference to the following description and attached drawing, wherein:

FIG. 1A is a simplified block diagram illustrating one embodiment of a method for acquiring net lease assets as part of a process for securitizing such net leases in accordance with the present invention.

FIG. 1B is a simplified block diagram illustrating one embodiment of a method for paying back the debt associated with acquiring the net lease assets as part of a process for securitizing such net leases in accordance with the present invention.

FIG. 2A is similar to FIG. 1A but for an alternative embodiment.

FIG. 2B is similar to FIG. 1B but for an alternative embodiment.

FIG. 3 is a more detailed block diagram of one embodiment of a method for securitizing net lease assets in accordance with the present invention.

FIG. 4 is a block diagram illustrating the sale-leaseback trust which forms a part of the securitization method in accordance with the present invention.

FIG. 5 is a block diagram illustrating the structure of the net lease CDO including the balloon payment provider which forms a part of the securitization method in accordance with the present invention.

FIG. 6 is a block diagram illustrating the structure of the net lease CDO execution which forms a part of the securitization method in accordance with the present invention.

FIG. 7 is an exemplary graphical illustration of the loan-to-value ratio as a function of time, where the loan equals the CDO debt outstanding and the value equals the fair market value of the underlying property under various scenarios.

FIG. 8 is an exemplary graphical illustration of the equity capitalization of the balloon payment provider as a function of the fair market value over time relative to its obligation.

FIG. 9 is a graphical illustration illustrating the number of U.S. insured commercial banking offices from 1934-2003.

FIGS. 10 A and 10B are exemplary block diagrams illustrating an investment approval process in accordance with one aspect of the invention.

FIGS. 11A and 11B illustrate exemplary sale-leaseback terms and conditions in accordance with one aspect of the present invention.

FIGS. 12A and 12 B illustrate lease default process of a financial institution participating in a net lease securitization in accordance with the present invention.

FIG. 13 is an exemplary capital structure of the CDO for use with the present invention.

FIGS. 14A-14C illustrates exemplary terms of the CDO transaction in accordance with the present invention.

FIGS. 15A and 15B illustrate an exemplary protocol for the priority of payments of the CDO transaction in accordance with the present invention.

FIG. 16 illustrates exemplary portfolio limitations and coverage tests for use with the present invention.

FIG. 17 is an exemplary graphical illustration of the effective recovery rate as a function of fair market value as a function of the percentage of outstanding CDO notes.

### DETAILED DESCRIPTION

The present invention relates to a financial securitization transaction, such as a collateralized debt obligation (CDO) transaction (referred to herein as a “net lease CDO”), that (i) is at least partially collateralized by a plurality of net lease assets where the tenants to the leases are financial institutions generally with assets of less than $10 billion, and (ii) where such securitization may not be fully collateralized by such net lease assets, in which case the remainder of the collateral for such securitization may consist predominantly of traditional financial institution collateral (including trust preferred securities, debt and/or surplus notes) and/or tranches of CDOs backed predominantly by such collateral. In accordance with an important aspect of the present invention, the ratings of the debt securities of the securitization rely on the aggregate pooled credit quality of the multiple financial institutions backing the various net lease assets and the geographic diversity of such financial institutions, instead of on the explicit investment ratings of any one of the individual obligors in the pool. In accordance with another important aspect of the present invention, as opposed to the typical 5%-10% recovery rate assumed for traditional financial institution collateral used in pooled financial institution obligation CDO transactions, the net lease assets are collateralized by property, which translates into a materially higher assumed recovery rate, for example, in excess of 40%. Through the mechanism of the balloon payment provider, another important aspect of the present invention, the net lease assets do not require any form of residual value insurance and the need for equity capital is significantly reduced or even eliminated.

The net lease CDO to which the present invention relates may also be executed as part of a larger securitization that includes other types of assets. For example, in addition to being collateralized with net lease assets where the tenants to the leases are financial institutions generally with assets of less than $10 billion and traditional financial institution collateral, the net lease CDO could also include as collateral the following: ABS, CMBS, CDOs, other real estate assets, residential mortgage backed securities (RMBS), corporate debt obligations or other debt securities or receivables.

As referred to herein “net lease assets” are net leases, the related leased properties and/or direct or indirect interests therein, loans secured by the net leases and/or such related leased properties, or other structured interests therein. As used herein, “financial institution” refers to both rated and unrated financial entities, such as banks, thrift institutions, credit unions, insurance companies or other similar financial institutions, or holding companies thereof.

CDO transactions are known where the assets consist of a pool of (i) trust preferred securities (also known as capital securities) or other preferred securities, (ii) subordinated debt, and/or (iii) in the case of insurance companies, surplus notes, in each case generally issued by twenty or more geographically diversified banks, thrifts, credit unions, insurance companies or other similar financials institutions, or holding companies thereof (such securities set forth in (i), (ii) and (iii) are referred to herein as “traditional financial institution collateral”). These CDO transactions (which are referred to herein as “pooled financial institution obligation CDO transactions”) may also have collateral that includes tranches of CDOs backed by traditional financial institution collateral. These pooled financial institution obligation CDO transactions rely on, among other things, (i) the low cumulative default experience of financial institutions and (ii) the geographic diversity of the issuing financial institutions in order to obtain favorable ratings from the rating agencies on the debt securities issued by the CDO used to finance the purchase of the collateral.

Analysis of the empirical historical financial institution default rates provides evidence of the existence and extent of segregated, regional default risk among financial institutions. This data shows a strong regional economic component to financial institution risk where the success of a regional financial institution is tied to the success of the regional economy in which it is located. As such, the United States has been divided into five distinct geographic regions, where each region behaves as a separate “industry sector” that is relatively uncorrelated to each of the other four regions. The degree of diversification achieved across these five geographic regions is similar to the diversification achieved across any five randomly selected Moody's industry classifications used in CDO transactions. For purposes of assessing diversification value in CDOs, Moody's has arrived at 33 industry classifications. The correlation of defaults is low among companies in separate Moody's industry classifications. When the issuers of the securities in a CDO transaction are widely disbursed across the 33 different industry classifications, the diversity is high. A higher amount of diversity permits higher amounts of leverage on a CDO due to a lower correlation of default risk, or could result in more favorable ratings on the debt securities issued by the CDO with no additional leverage. More favorable ratings result in lower overall funding costs to the CDO. Both higher leverage and lower funding costs lead to more profitability to the sponsor of the CDO. A portfolio comprised of financial institutions from the five geographic regions provides as much diversity as a portfolio comprised of companies from any given five Moody's industry classifications. It is noted that the number of geographic regions used for assessing diversity as well as the number of industry classifications may increase or decrease in the future.

Pooled financial institution obligation CDO transactions also rely on the low cumulative default experience of the issuing financial institutions in order to obtain the favorable ratings from the rating agencies. Most of the financial institutions that have issued securities that have been used as collateral for the pooled financial institution obligation CDOs have not had explicit ratings from the rating agencies and have assets less than $10 billion. Other empirical default data compiled and analyzed by the inventors using FDIC and Federal Reserve Bank sources and, using a broad definition of “default”, illustrates that the cumulative default experience of FDIC-insured banks is similar to Moody's A/Baa-rated corporate and industrial credits.

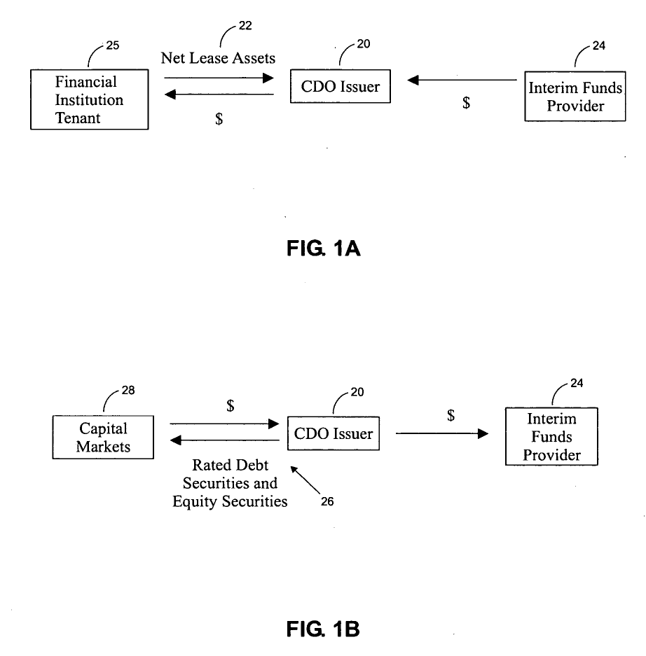

The net lease CDO in accordance with the present invention can be structured a number of ways. In one embodiment of the invention, for example, as illustrated in FIGS. 1A and 1B, a CDO issuer 20 is formed and effectively acts as a “warehouse” for accumulating the net lease assets 22, for example, from financial institutions 25. The CDO issuer 20 obtains the funds necessary to buy the net lease assets 22 from an entity 24 that provides interim funding (an “interim funds provider”), such as a bank facility or the like. When a critical amount of collateral is obtained, the CDO issuer 20 sells rated debt securities as well as equity securities 26 in the capital markets 28 and uses the proceeds to pay back the interim funds provider 24.

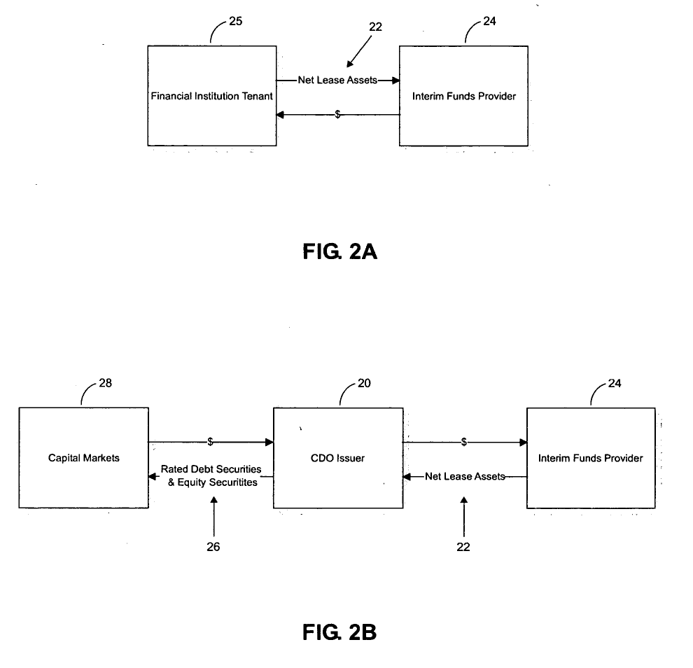

The collateral accumulation may also be done in a more traditional way, for example, as illustrated in FIGS. 2A and 2B, where a interim funds provider 24, such as a bank or broker dealer, accumulates the net lease assets 22 and acts as a “warehouse” during an accumulation period. A list of accumulated assets may be stored on a database on a personal computer. When a critical amount of collateral is obtained, the warehouse provider sells the collateral to the CDO issuer 20 which, in turn, sells its rated debt securities as well as its equity securities 26 in the capital markets 28 to fund the CDO issuer's purchase of the collateral from the interim funds provider. However, this more traditional collateral accumulation strategy may be less efficient since it potentially involves two transfers of real estate—one from the initial seller (which would also be the tenant to the net lease in the event of a “sale-leaseback”) to the warehouse provider and one from the warehouse provider to the CDO issuer. In one embodiment, the CDO issuer 20 purchases the underlying real estate from the start and the inconvenience (and the potential for having to pay two sets of transfer taxes) of two transfers of the underlying real estate may be avoided.

In either case, the CDO issuer 20 is able to obtain favorable ratings from the rating agencies on the rated debt securities that are sold in the capital markets to fund the purchase of the net lease assets 22 (or to pay off the interim funds provider 24) because of the geographic diversity of the financial institutions that are obligors on the net lease assets 22 and the low cumulative default probabilities of such financial institution obligors, as opposed to relying on the explicit public credit ratings of a single obligors in the pool as in the prior art. The greater the geographic diversity among the obligors and the greater number of distinct obligors on the net lease assets 22, the more favorable the ratings on the debt securities issued by the CDO issuer 20, which leads to lower funding costs on such debt securities.

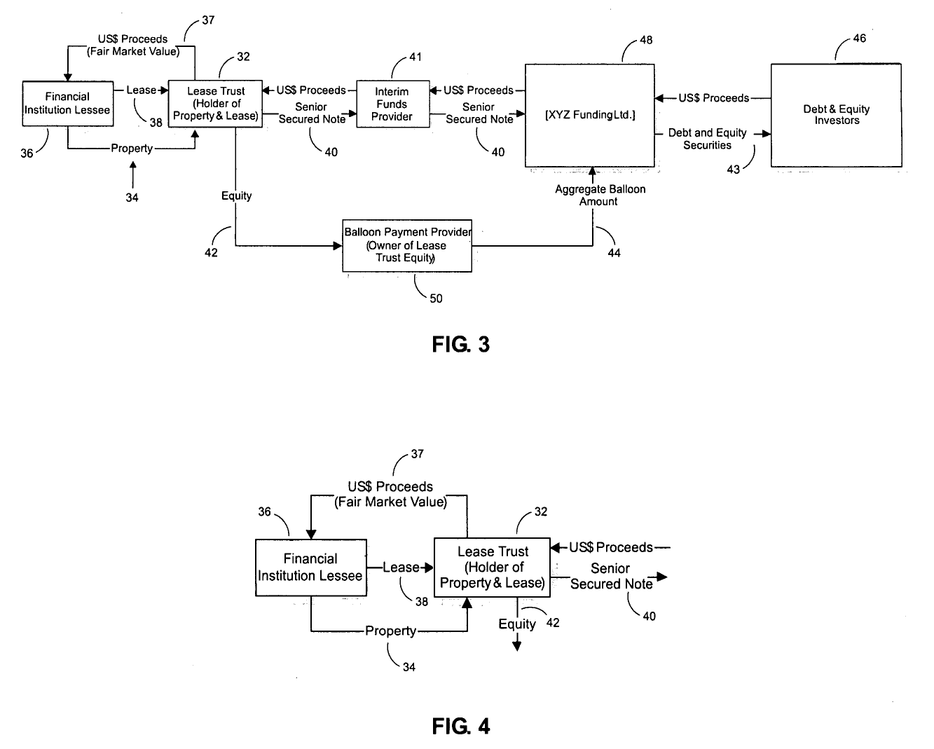

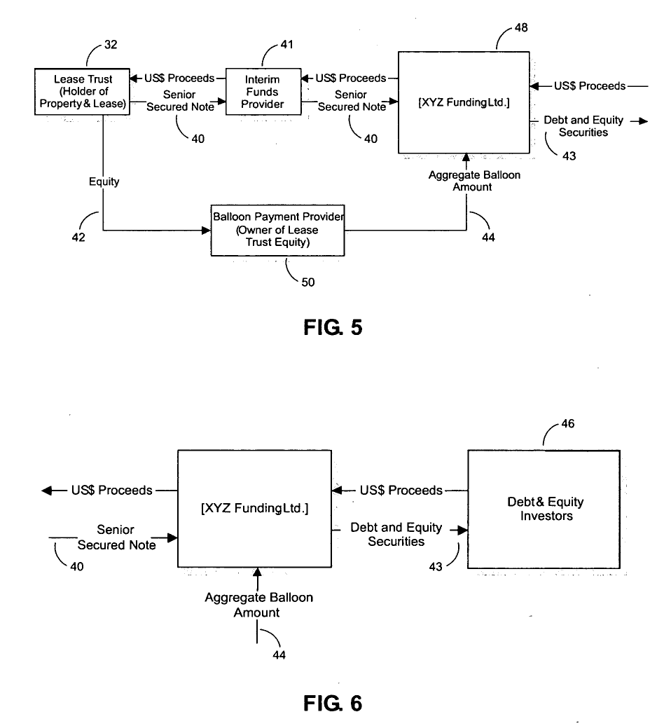

Another embodiment of the net lease CDO in accordance with the present invention, for example, is illustrated in FIGS. 3-6. The transaction may be understood as being comprised of three separate structures, for example, as illustrated in FIGS. 4-6. In particular, FIG. 4 illustrates the structure for the sale-lease back trust. FIG. 5 illustrates the structure for the net lease CDO including the operation of the balloon payment provider while FIG. 6 illustrates the execution of the CDO. Each structure is discussed below.

FIG. 3 illustrates an overview of the structure of the net lease CDO in accordance with the present invention which illustrates the cash flows. In general, in this embodiment, lease trusts 32 are created to hold the property 34 which is leased to a financial institution on a net lease basis 38 and the property is purchased at fair market value 37 by selling senior secured notes 40 and, if necessary, equity 42. In some cases, the property is acquired in a sale-lease back transaction, where the lease trust 32 purchases the property from the financial institution and leases it back to such financial institution 36. The senior secured notes 40 may be secured by (i) non-deferrable long term net leases, for example, 15 to 20 year leases 38 with financial institutions 36 on bank branch real estate or other real property 34 and (ii) the related bank branch real estate or other real property 34. The net lease CDO 48 may be collateralized by, for example, 20 to 50 different senior secured notes 40 in a manner substantially similar to that involved in the structuring of existing pooled financial institution obligation CDOs, subject to rating agency criteria. Or, the net lease CDO may be collateralized by at least one senior secured note 40 and the remainder of the collateral for such securitization may consist predominantly of obligations (including trust preferred securities, debt and/or surplus notes) of financial institutions, and/or CDO securities whose collateral consists of such obligations. The senior secured notes 40 may be warehoused by a interim funds provider 41, such as a bank or broker dealer, and when a critical amount of collateral is obtained, the interim funds provider sells the senior secured notes 40 to the CDO 48 which sells debt and equity securities 43 in the capital markets to debt and equity investors 46 to fund the purchase of the senior secured notes 40 from the interim funds provider 41.

FIG. 4 illustrates the sale-leaseback trust portion of the transaction. In particular, a financial institution 36 sells its real property 34 and leases it back for a period of, for example, 15-20 years. A lease trust 32 is established to purchase the real property or other real estate assets 34 at fair market value, as indicated by the arrow 37 and enter into a long term lease 38 with the seller/lessee financial institution 36. The lease trust 32 leases back the real estate assets 34 to the financial institution 36, by way of long term leases, represented by the arrow 38, thus becoming the lessor of the property 34. In order to finance the purchase of the real estate assets 34, the lease trust 32 may fund itself in various ways, such as, through the issuance of (i) a non-deferrable senior secured note 40, collateralized by the real estate assets 34 and/or the leases 38 and (ii) equity 42 to purchase such sale-leaseback real estate assets 34 at fair market value 37. The senior secured notes 40 may be either fully or partially amortizing during their respective lives based on, for example, whether enough cash flow is generated through payments on their respective leases 38. If the senior notes are not fully amortizing, then a balloon payment will be due at the maturity of such senior note, for example, between 0-50% or more of the original principal amount, measured in current non-inflation adjusted dollars. The lease payments are used to make interest and principal payments on the senior secured notes 40. The senior secured notes 40 are pooled together (or with other obligations of financial institutions or CDOs collateralized by obligations of financial institutions) by the net lease CDO and payments received on the senior secured notes 40 (and the remaining assets in the pool where applicable) are used to pay principal and interest to the debt and equity investors in the net lease CDO.

FIG. 5 illustrates the structure for the net lease CDO 48 including the operation of the balloon payment provider 50. A special purpose vehicle, identified as XYZ Funding, Ltd. 48, is used to represent the net lease CDO, which, in this example, represents a leveraged repackaging of 100% senior secured notes 40 which are secured by the net lease assets (properties 34 and leases 38). The collateral of the net lease CDO 48 is a pool of senior secured notes 40 backed by leases from, for example, between 20-40 financial institutions. A collateral manager manages the selection, acquisition, servicing and disposition of the senior secured notes 40 that collateralize the net lease CDO 48. The net lease CDO 48 is used to raise proceeds to purchase the senior secured notes 40 issued by the various lease trusts 32. In lieu of holding only senior secured notes 40 as collateral, the net lease CDO 48 may be collateralized by at least one senior secured note 40 and the remainder of the collateral for such net lease CDO may consist predominantly of traditional financial institution collateral (including trust preferred securities, debt and/or surplus notes) of financial institutions) and/or tranches of CDOs backed predominantly by such traditional financial institution collateral.

The balloon payment provider 50 holds the equity 42 of the lease trusts 32. On the closing date of the net lease CDO, an amount representing the aggregate, scheduled, unamortized balance at maturity of the senior secured notes 40 of the various lease trusts 32 is calculated which amount is the aggregate balloon amount 44 (which equals the sum of the “nominal residuals” of all senior secured notes). For clarification, a “balloon amount” referred to herein is the “nominal residual” of a single senior secured note. The balloon payment provider 50 is obligated to pay to the net lease CDO 48 the aggregate balloon amount 44 by the maturity date of the net lease CDO 48. The balloon payment provider 50 may satisfy part or the entire aggregate balloon amount 44 prior to maturity under certain circumstances described below. The balloon payment provider 50 may secure the aggregate balloon amount 44 obligation with a first mortgage lien on 100% of the equity 42 of the various lease trusts 32 held by the balloon payment provider 50.

In lieu of having a balloon payment provider 50, if the senior secured notes 40 are not fully amortizing, then (i) a residual guaranty insurer or a similar type of entity could guarantee payment of the aggregate balloon amount 44 by the maturity date of the net lease CDO 48, or (ii) a residual guaranty insurer or a similar type of entity could guarantee payment of the balloon amount due on each senior secured note 40 by the maturity date of such senior secured note 40, or (iii) equity could be injected into each lease trust 32 or into the net lease CDO 48 in such amounts such that a balloon payment provider 50 or a residual guaranty insurer as set forth in (i) or (ii) above is not needed. These alternatives to the balloon payment provider 50 may be more costly to implement and may impact the profitability of the net lease CDO. If any lease trust 32 defaults on its senior secured notes 40 (which may occur because a financial institution 36 defaults on payments on its lease 38) and the property 34 cannot be re-leased to a qualified financial institution, the property 34 may be liquidated and a recovery on the lease obligation may be pursued. Proceeds from such liquidations, to the extent available, may be used to repay the related senior secured note 40 with the following potential affects on the aggregate balloon amount 44 obligation of the balloon payment provider 50:
(i) Amounts up to the scheduled balloon amount or nominal residual with respect to such note covered by the balloon payment provider 50 will reduce the balance of the aggregate balloon amount 44 due from the balloon payment provider 50 at the maturity date of the net lease CDO 48.
(ii) Amounts in excess of the scheduled balloon amount or nominal residual on such note as set forth in (i) above, but less than the outstanding balance of the related senior secured notes 40, will have no effect on the balance of the aggregate balloon amount 44 due from the balloon payment provider 50 at the maturity date of the net lease CDO 48.
(iii) Amounts recovered in excess of the outstanding balance of the related senior secured note 40 may be paid to the balloon payment provider 50 and held in escrow in the form of eligible investments. At the discretion of the balloon payment provider 50, such amounts may be paid to the net lease CDO 48 as principal collections in satisfaction of an equal amount of the aggregate balloon amount 44 due from the balloon payment provider 50 due at maturity, until such aggregate balloon amount obligation 44 has been fully satisfied. This discretionary payment to the net lease CDO 48 may be accomplished by the balloon payment provider 50 using amounts in excess of the outstanding balance of the related senior secured note 40 to prepay each of the remaining senior secured notes 40 of all of the lease trusts whose equity 42 is owned by the BPP 50, which prepayment may occur on a pro rata basis.

Even in the absence of a default on a senior secured note 40, the balloon payment provider 50 may sell property 34 for an amount not less than the outstanding balance of the related senior secured note 40 with the proceeds from such liquidation applied with the same affects set forth above.

FIG. 6 illustrates the execution of the net lease CDO 48. The net lease CDO 48 is expected to take the form of a traditional pooled financial institution obligation CDO, issuing multiple classes of debt and equity securities 43 to the debt and equity investors 46 in order to purchase the senior secured notes 40 issued by the lease trusts 32. In one embodiment, the senior secured notes 40 may be warehoused by a interim funds provider 41, such as a bank or broker dealer, and when a critical amount of collateral is obtained, the interim funds provider 41 sells the senior secured notes 40 to the net lease CDO 48.

Sale-leaseback financing most commonly involves a company selling one or more properties and/or equipment to an investor—individual, company, pension find or group—for fair market value. The investor/landlord provides the seller with a bondable lease for a negotiated period of 15 to 20 years. The seller/tenant pays the investor a negotiated annual rent, typically with fixed annual adjustments to mitigate the effects of inflation.

Financial institutions are known to require a substantial amount of real estate to conduct their businesses; however, few institutions profit from owning these properties. The cash and credit tied up in facilities and land represents capital that could be deployed more productively in the institutions' core business operations.

Financial institutions routinely seek financing to expand their business, fund acquisitions, pay down debt or construct new facilities. Options include issuing trust preferred securities or subordinated debt, issuing common or preferred stock, or selling assets—options which can be expensive and onerous. Sale-leaseback financing provides a company with access up to 100% of the value of those fixed assets, generating funds that can be used for other corporate initiatives or liquidity, while providing the company full control of its facilities.

One of the more significant benefits of a sale-leaseback transaction is that it allows businesses to free capital tied up in real estate and/or equipment. More importantly, a significant portion of these funds (equal to the gains on sale) become “core capital”. Unlike Tier-1 qualifying trust preferred securities, which are limited to a small percentage of a financial institution's capital base, there is no regulatory limitation on the amount of core capital that can be raised through sale-leaseback transactions.

The value of real estate assets remains largely intangible for as long as the business owns the property. As a result, a substantial amount of capital that a company can use more productively to expand or improve its primary business is tied up in these assets. Traditional financing methods, such as a mortgage, allow the owner of the property to cash-out only a portion of the value of the property due to loan-to-value limitations. Sale-leaseback financing, however, will usually offer liquidity up to 100% of an asset's value.

### Advantages of a Sale-Leaseback Transaction

Several advantages of a sale-leaseback transaction in accordance with the present invention include:
The sale-leaseback provides the lessee with cash equal to 100% of the fair market value 37 of the property 34. A strong real estate market as exists at the date of this application presents an attractive opportunity to unlock 100% of the value of a seller/lessee's real estate holdings.
The cash proceeds representing profits may add to the financial institution's core capital, which can be deployed in the financial institution's core business and, presumably, achieve a higher return than would an investment in a bank branch.
While unlocking 100% of the value of the property 34, the seller/lessee financial institution 36 retains the use of the property 34.
The effective interest rate on the lease payments is at a very attractive level and is guaranteed for the lease term.
Trust preferred financing for banks is limited to 25% of such financial institution's Tier-1 capital. Funds raised through sale-leaseback transactions are limited only by the amount of property owned by the financial institution.
The sale-leaseback may be structured to remove the property 34 from the financial institution lessee's balance sheet.
Any profits generated through the sale of the property 34 are added to the financial institution's income statement. With conventional financing, an owner/borrower must show the financing as a liability on its balance-sheet and must record annual depreciation charges as an expense on its income statement. However, an off-balance sheet sale-leaseback may improve the seller/lessee's reported earnings, return on assets and debt-to-equity ratio as compared to conventional financing.
If the financial institution is a bank and is constrained by the regulatory restrictions on the financial institution's ownership of “bank premises” (as set forth in Section 208.20 of Regulation H for Federal Reserve-regulated banks and, 12 C.F.R. Part 5, Subpart C, section 5.37 for National Banks and any similar state regulation), the sale-leaseback will permit the lessee to expand its branch network at a faster rate.

### Net Lease CDO vs. Pooled Financial Institution Obligation CDO

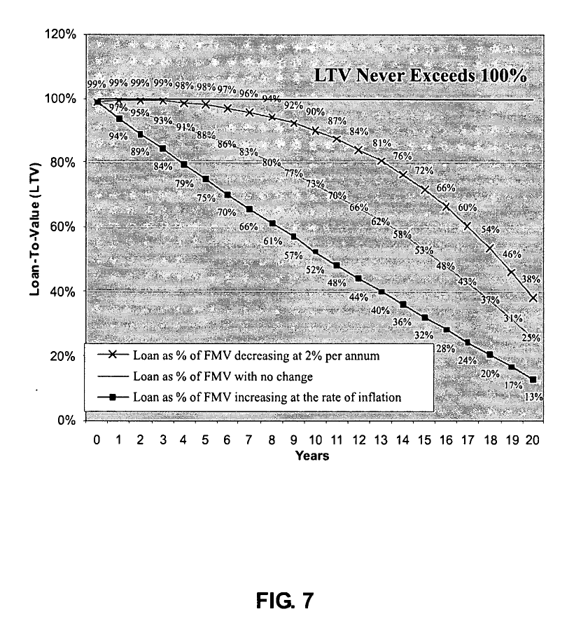

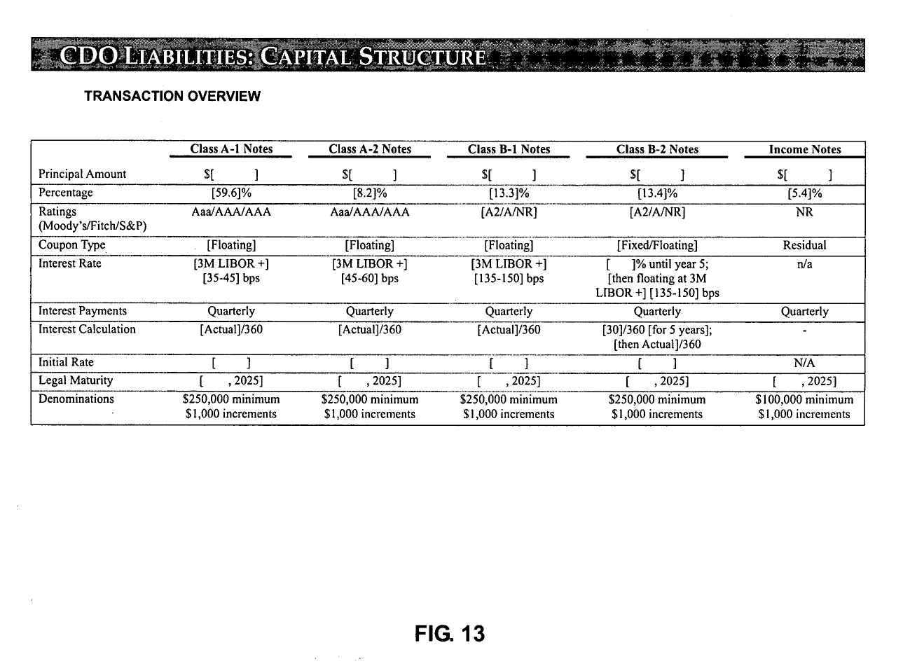

The collateral of the net lease CDO 48 to which the present invention relates are net lease assets as opposed to traditional financial institution collateral that serve as collateral for the pooled financial institution obligation CDOs. The advantages of such collateral over traditional financial institution collateral include the fact that lease payments are non-cancelable, and unlike traditional financial institution collateral, are non-deferrable, senior obligations of financial institutions.
Other advantages include the fact that lease trusts 32 are collateralized by property 34 in addition to a lease, which translates into a materially higher assumed recovery rate, for example, in excess of 40%, in an event of default, rather than the typical 5%-10% recovery rate assumed for traditional financial institution collateral.
Unlike traditional financial institution collateral, which is bullet-pay (i.e., 100% of principal is due at maturity), the senior secured notes 40 issued by the lease trusts 32 are amortizing debt instruments, returning principal with cash flow derived from annual rent increases. The lease trusts 32 return a significant portion (for example, in certain instances greater than 65%) of principal on the related senior secured notes 40 prior to their respective maturities, thus shortening the risk profile to investors. Though the legal final maturity of the senior secured notes 40 may be 15 or 20 years, because of the amortization of the senior secured notes, the pool-wide weighted average life (“WAL”) of the senior secured notes collateralizing a net lease CDO is expected to be 8.28 years as opposed to a legal final maturity of 30 years and a WAL of 30 years for the pool of traditional financial institution collateral collateralizing a pooled financial institution obligation CDOs.
Based on the exemplary terms of the net lease CDO 48 set forth in FIGS. 13 through 16, the portfolio of senior secured notes 40 is expected to amortize the lease trust CDO's debt to approximately 25% of its initial principal amount solely from the lease payments under the terms of the leases 38 paid by the financial institutions to the related lease trusts 32. Based on the exemplary terms, the aggregate balloon amount 44 owed by the balloon payment provider 50 will be an amount equal to 33% of the original principal amount of the senior secured notes 40. This amortization of the senior secured notes 40 is accomplished through payments on the net leases 38 by the financial institution lessees 36, and does not rely on any value of the underlying property 34, and hence does not require liquidation or refinancing of such property 34.
The payment of the balloon amount or nominal residual at the maturity of each lease trust 32 will be made through the liquidation or refinancing of the property 34 collateralizing the respective lease trust 32. Traditional financial institution collateral, on the other hand, leaves a balloon equal to 100% of book value, payable by the respective financial institution. As a result, investors are relying heavily on a financial institution's ability to refinance/retire its debt.
Investors receive a significant amount of principal prior to the maturity of the senior secured note 40 and thus have a lower dollar amount of balloon risk exposure than the balloon risk inherent in bullet-pay collateral like the traditional financial institution collateral. Unlike such collateral, the senior secured notes 40 issued by the lease trusts 32 have a readily identifiable/earmarked and marketable real property asset 34 available for refinancing or liquidation to mitigate the limited balloon risk.
The percentage of outstanding net lease CDO 48 debt to the value of the property 34 underlying all of the lease trusts 32 at the maturity date of the net lease CDO 48 is referred to herein as the “aggregate effective residual.” Assuming the property 34 appreciates at the historical rate of inflation, or 3.42% per annum¹, over a, for example, 20-year term, the aggregate effective residual is expected to equal, for example, 13% (measured as a percentage of the appreciated fair market value of the property 34). Given the relatively small size of the aggregate effective residual, the property 34 could be refinanced via (presumably) a multitude of available traditional real estate lenders (i.e., banks) that are willing to lend on real property at a minimum loan-to-value (“LTV”) of, for example, 13% which loan proceeds would be enough to pay off the outstanding net lease CDO 48 debt. An exemplary illustration of the LTV as a function of fair market value is illustrated in FIG. 7.
   ¹ Source: U.S. Department of Labor Bureau of Labor Statistics, “History of CPI-U U.S. All Items Indexes and Annual Percent Changes From 1913 to Present.”
Additionally, the property could be liquidated via (presumably) a multitude of available buyers that are willing to buy real property at minimum of, for example, 13 cents on the dollar and the sale proceeds would be enough to pay off the outstanding net lease CDO 48 debt. Potential buyers may include some or all existing financial institution tenants after the expiration date of their respective leases or any number of real estate investment trusts (REITs).
Financial institutions have a great incentive to stay current on their lease payments to avoid eviction from the premises since the operations of brick and mortar banks require the use of their branches. Taking away this utility may lead to a partial or complete discontinuation of a bank's operations, a far more serious consequence than the failure to meet the debt service of its deferrable traditional financial institution collateral or even non-deferrable debt.
When compared to pooled financial institution obligation CDOs, the collateral manager of a net lease CDO has more flexibility should a financial institution obligor default. This includes the ability to sell the property 34 securing a senior secured note 40 and the ability to re-let the property 34 to another qualifying financial institution.

### Balloon Payment Provider

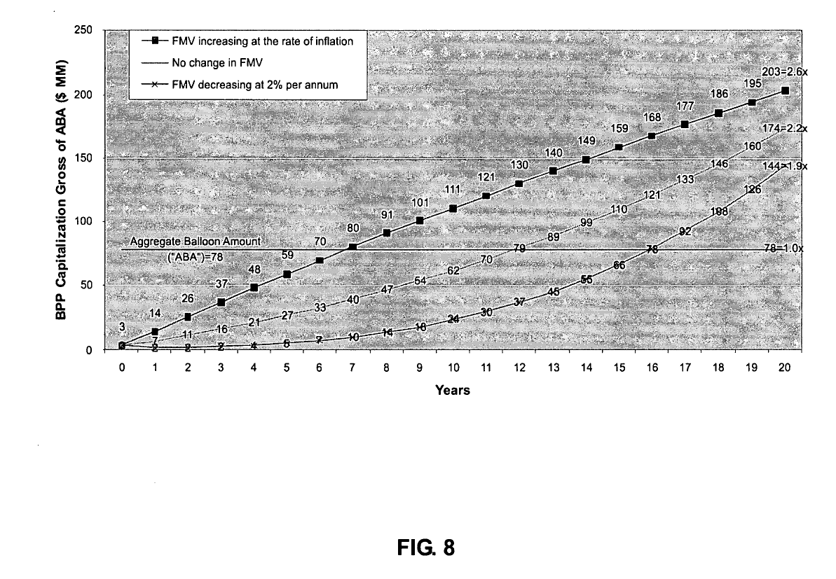

The balloon payment provider 50 will build a significant amount of capitalization to cover its aggregate balloon amount 44 obligation prior to the net lease CDO's maturity date. In the example illustrated in FIG. 8, the aggregate balloon amount 44 due is $78 MM given a $233 MM pool of senior secured notes or 33% of the underlying property's initial fair market value measured in today's non-inflation adjusted dollars. As shown in FIG. 8, the capitalization of the balloon payment provider 50 increases i) as the net lease CDO's debt amortizes, and ii) as the value of the properties 34 increase. Even where the fair market value of the property decreases at 2% per annum over the life of the net lease CDO (for example, 20 years), the capitalization of the balloon payment provider 50 at the maturity of the net lease CDO will equal 1.9 times the amount of the outstanding net lease CDO debt at the maturity of the net lease CDO.

### Asset Origination Methods

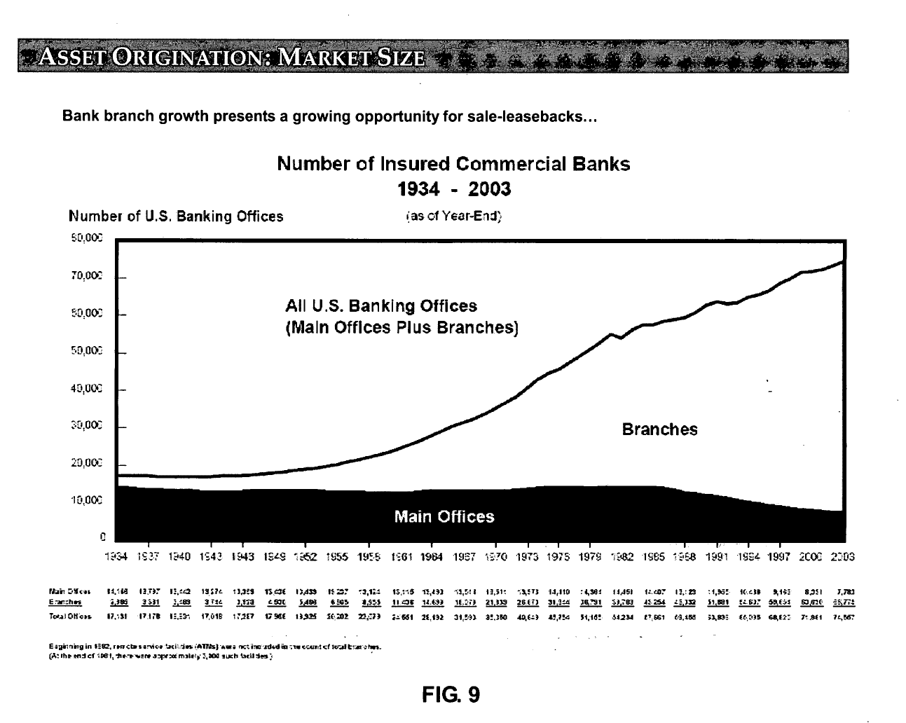

Collateral is sourced through several channels proven effective acquiring traditional financial institution collateral. The use of multiple origination channels allows the collateral manager to reach a wide geographic variety of financial institutions. In particular, as mentioned above, the CDO manager may target financial institutions to engage in a sale-leaseback by either selling property that they already own or by buying property in a prime location, then quickly selling it thereafter, entering into a long-term lease of the property as part of the transaction. In addition, the collateral manager may target third-party owners/lessors of property of which financial institutions are existing tenants, thereby obtaining an existing or negotiating a new long-term lease with a qualified financial institution as part of the transaction. In either case, the lessee is the financial institution. FIG. 9 illustrates the number of insured commercial banking offices from 1934-2003.

Various asset origination channels are contemplated as set forth below.
Direct calling effort to existing issuer clients from previous pooled financial institution obligation CDOs.
Relationships with regional broker-dealers that maintain long-standing relationships with financial institutions in their respective regions
Senior level contacts to trade groups (ABA, ACB, WIB, etc.)
Law firms and other advisors

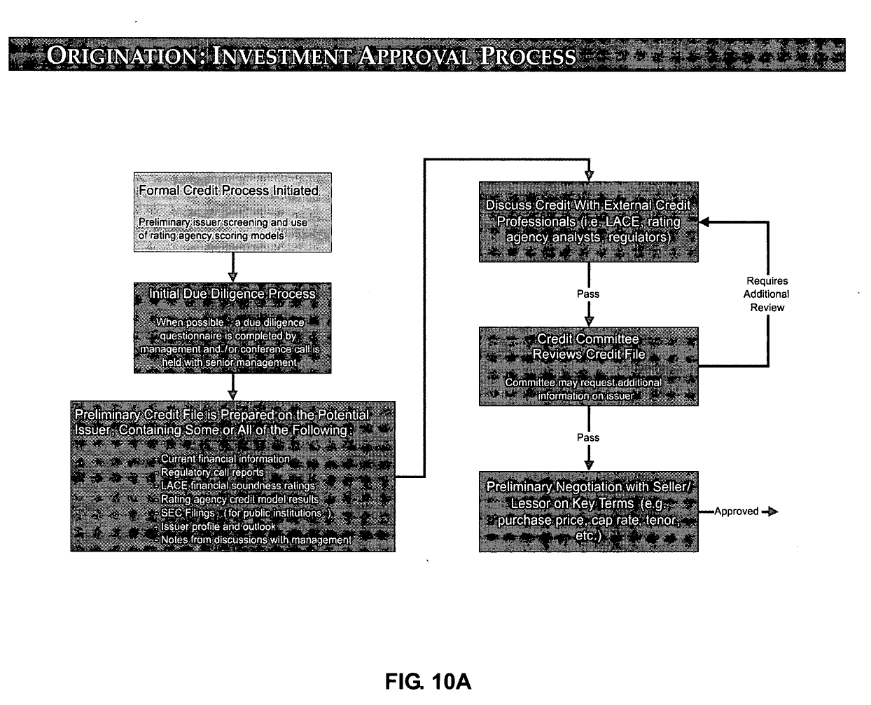

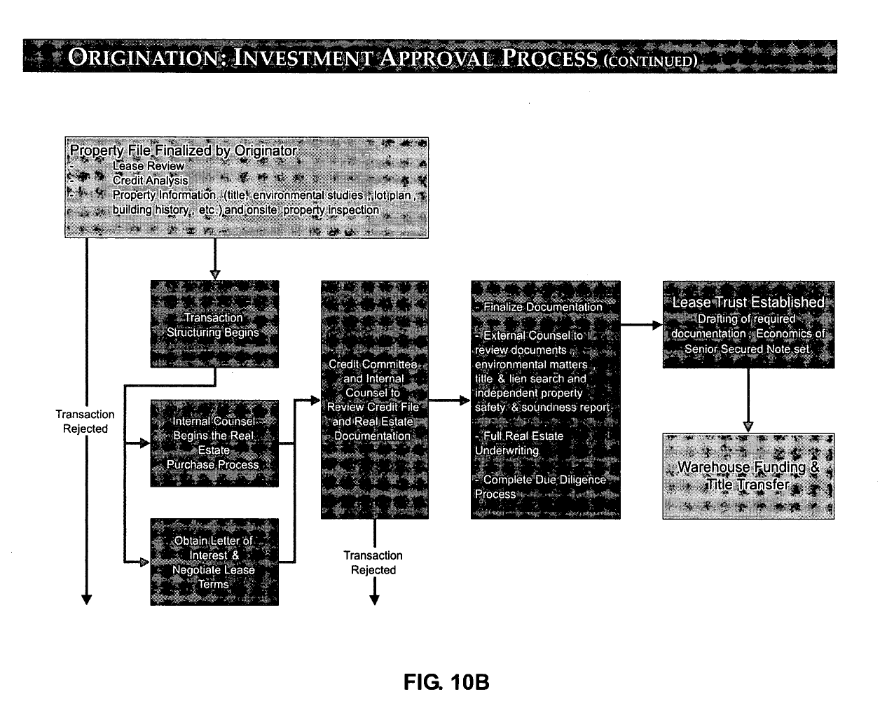

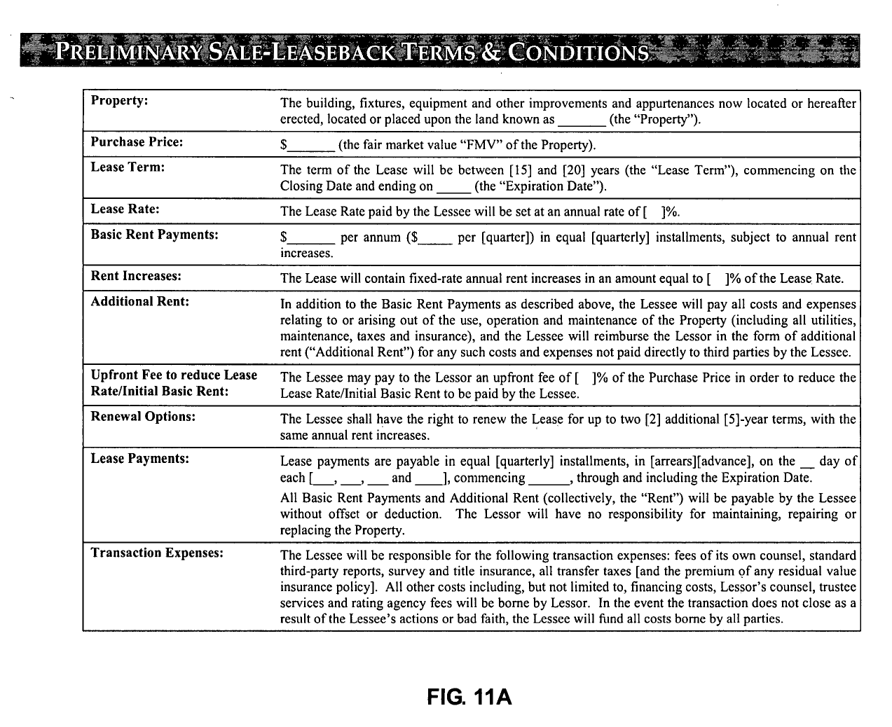

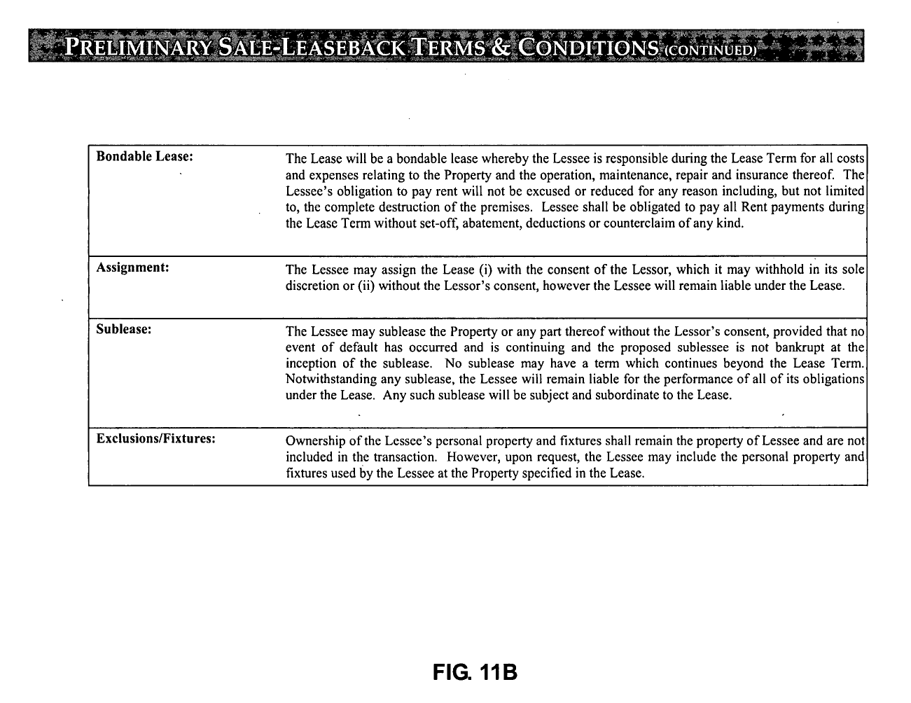

An exemplary asset approval process for acquiring assets is illustrated in FIGS. 10A and 10B. The status of this process may be tracked on an electronic database. Exemplary terms and conditions of the sale-leaseback are illustrated in FIGS. 11A and 11B.

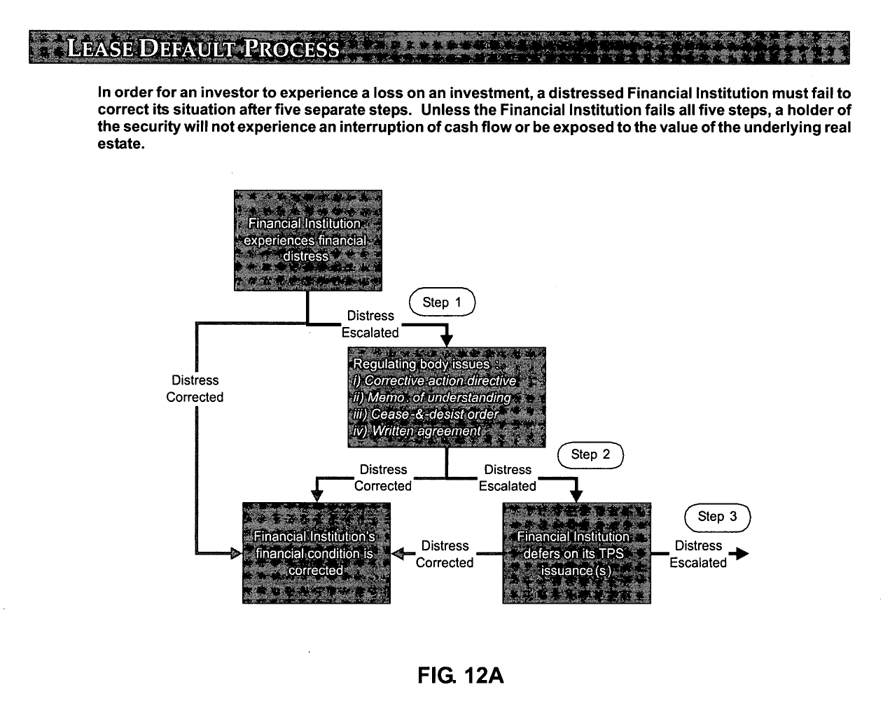

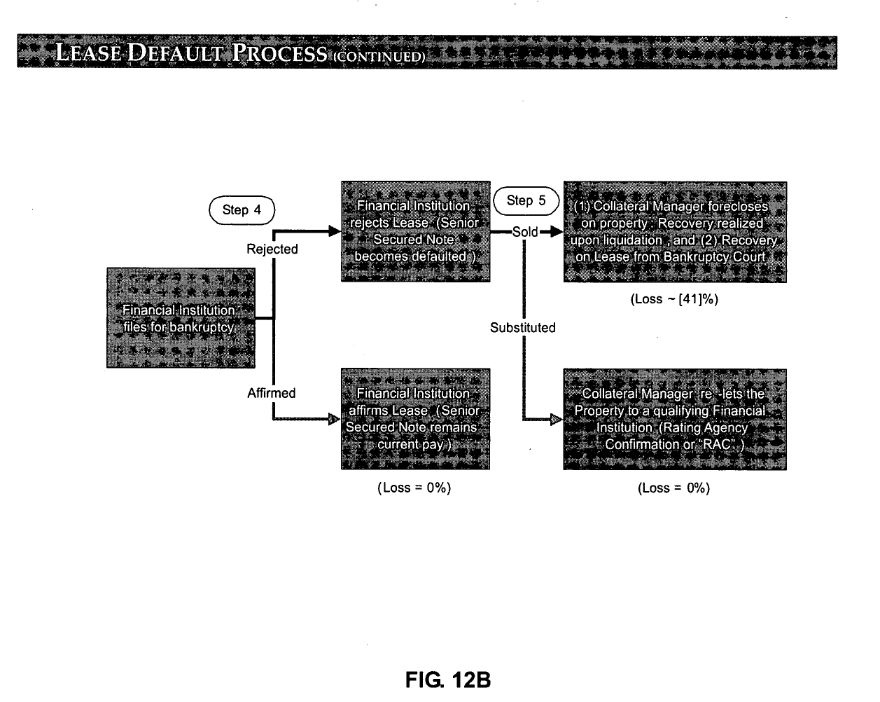

In order for an investor in a lease trust to experience a loss on an investment, a distressed financial institution must fail to correct its situation, for example, after five separate steps as illustrated in FIGS. 12 A and 12 B. Unless the financial institution fails all five steps, a holder of the senior secured note 40 will not experience an interruption of cash flow or be exposed to the value of the underlying real estate 34.

The senior secured note issued by each lease trust 32 may be secured by a first-priority mortgage in the property 34 and a senior claim on the lease 38 and rent payments. In the event that a financial institution 36 suffers financial difficulty, the collateral manager has several methods for realizing the maximum possible recovery.

If the financial institution lessee 36 suffers financial problems that cannot be worked out by the applicable regulators through a regulatory agreement, an unassisted merger with a healthy financial institution, or a forced merger with the same, the collateral manager can realize the recovery value in several ways:
The collateral manager can attempt to re-lease the property 34 to a healthy financial institution lessee 36 such that scheduled payments will continue to be made on the lease trust's senior secured note 40 (such replacement may be subject to Rating Agency Confirmation or “RAC”, confirming that the rated notes of the net lease CDO would not be downgraded as a direct result of the replacement).
The collateral manager can realize recoveries on both the property 34 (sale of property) and the lease 38 (claim in bankruptcy court).

With respect to the property 34:
If the balloon payment provider 50 does not re-lease the property 34 to an acceptable healthy financial institution lessee, then the balloon payment provider 50 may be required to sell the property 34 and use the sale proceeds as set forth in SS0040 above.

With respect to the lease, in the event of the bankruptcy or insolvency of the financial institution lessee, the net lease CDO can realize value on its senior claim on the lease 38 and rent payments. The debtor financial institution lessee 36 may assume the unexpired lease 38, in which case it will be required to pay all back rent and provide adequate assurance of future payments. For example, if the debtor financial institution lessee 36 rejects the unexpired lease 38 and the financial institution lessee is subject to the US Bankruptcy Code, then the net lease CDO will have a claim in the bankruptcy of the financial institution resulting from the termination of the lease in amount equal to the sum of (i) any unpaid rent due under the lease, and (ii) the greater of (x) the next 12 months of rent due under the lease, and (y) or 15%, not to exceed three years, of the remaining term of such lease.

### Capital Structure

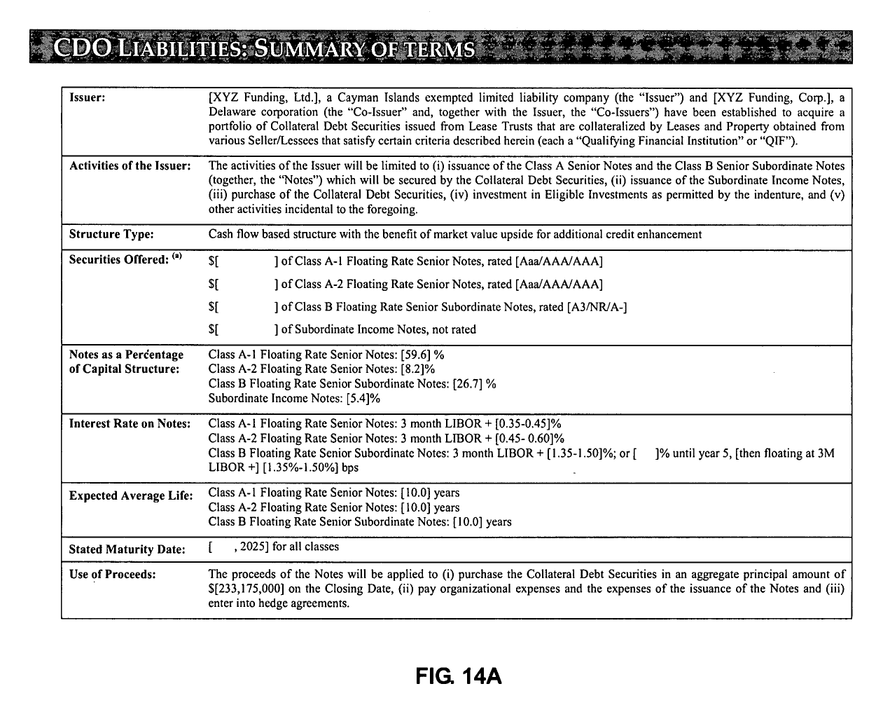

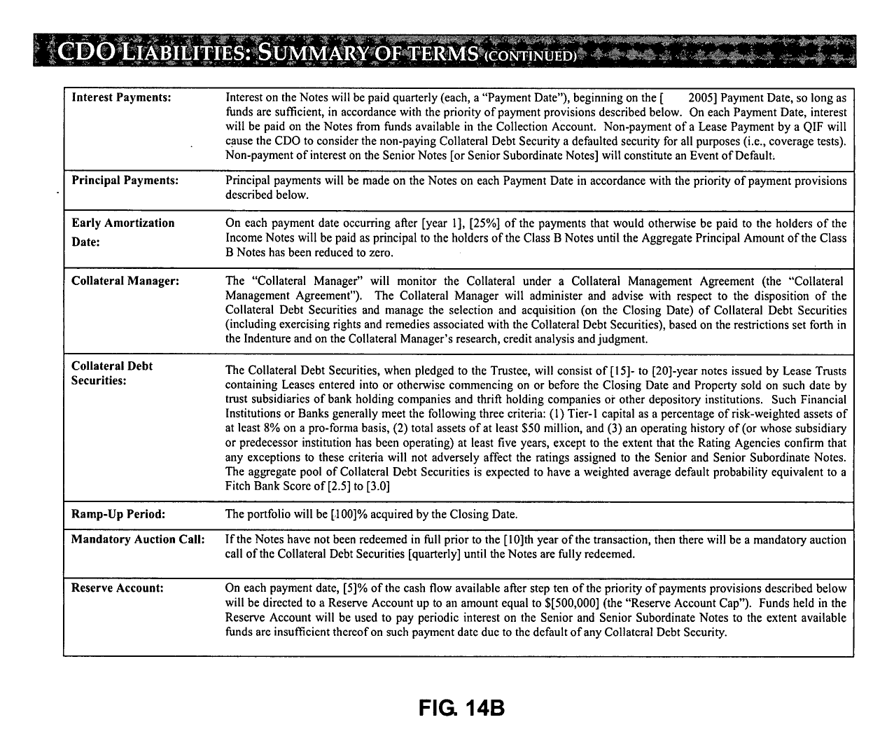

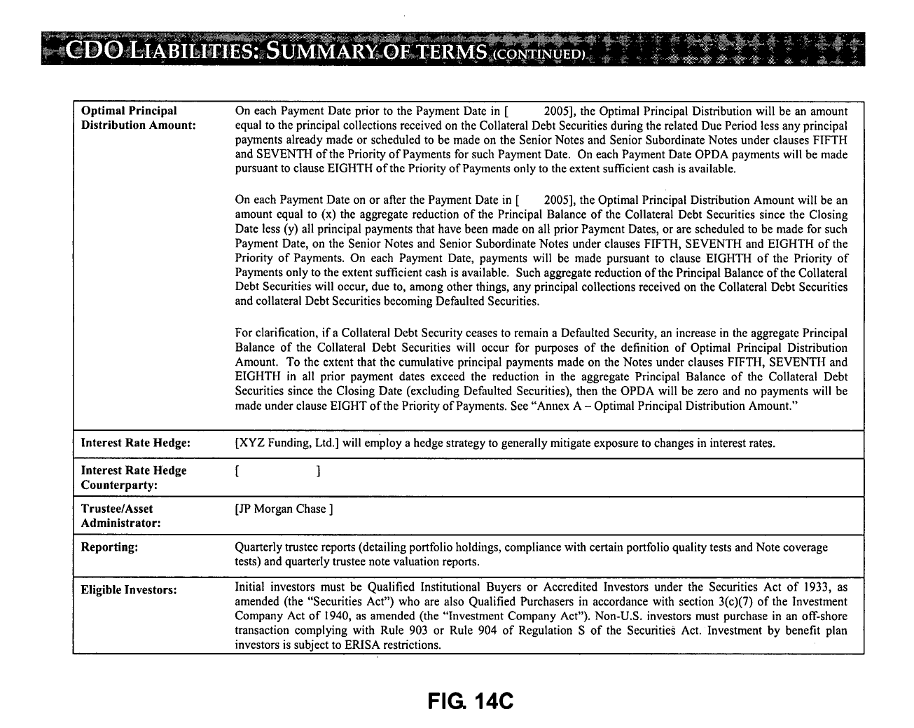

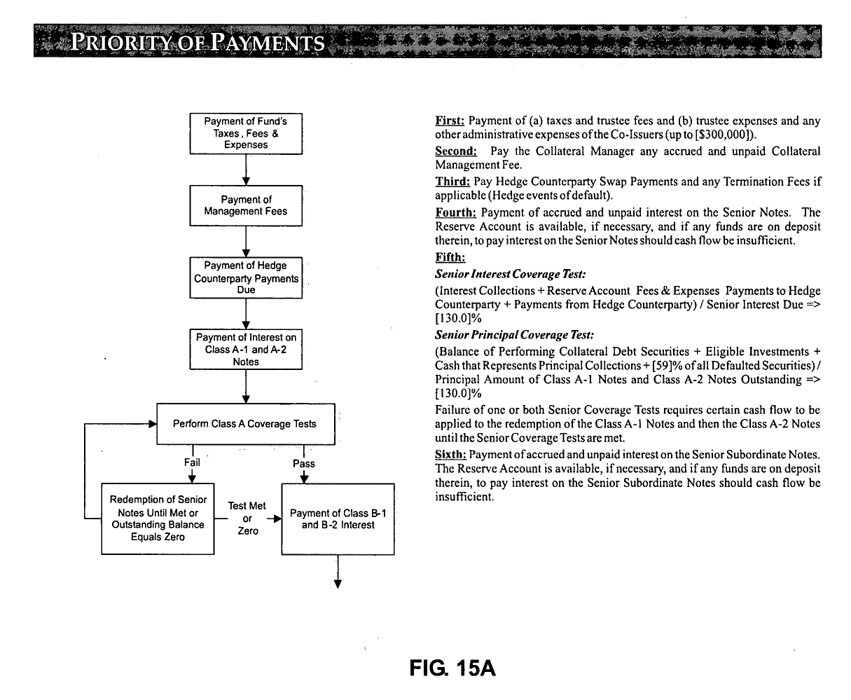

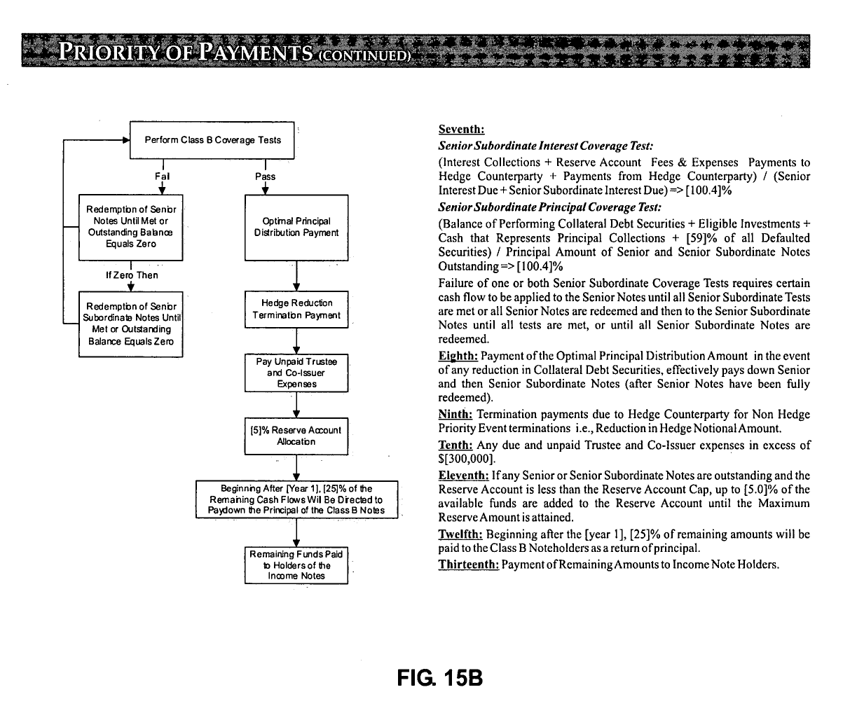

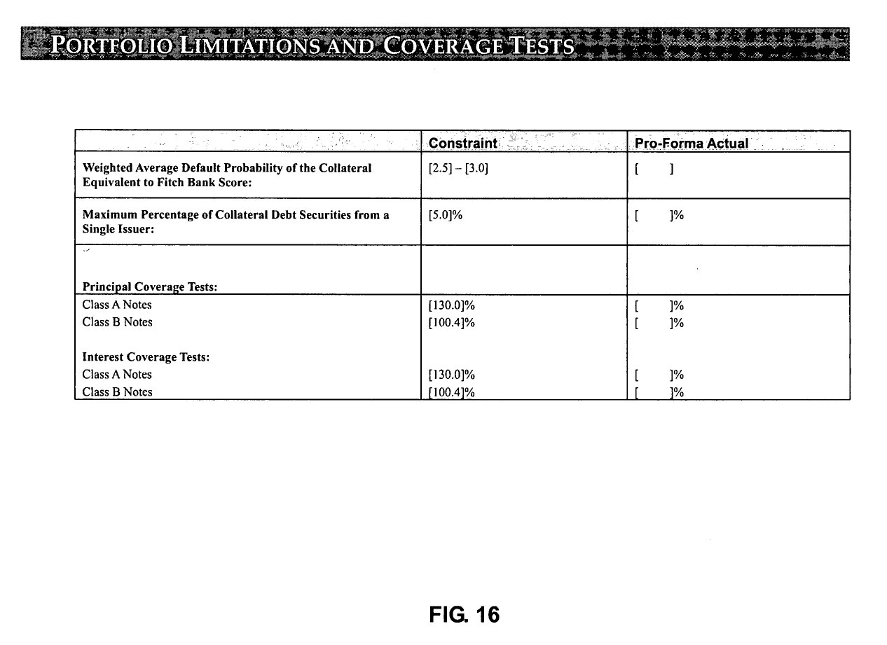

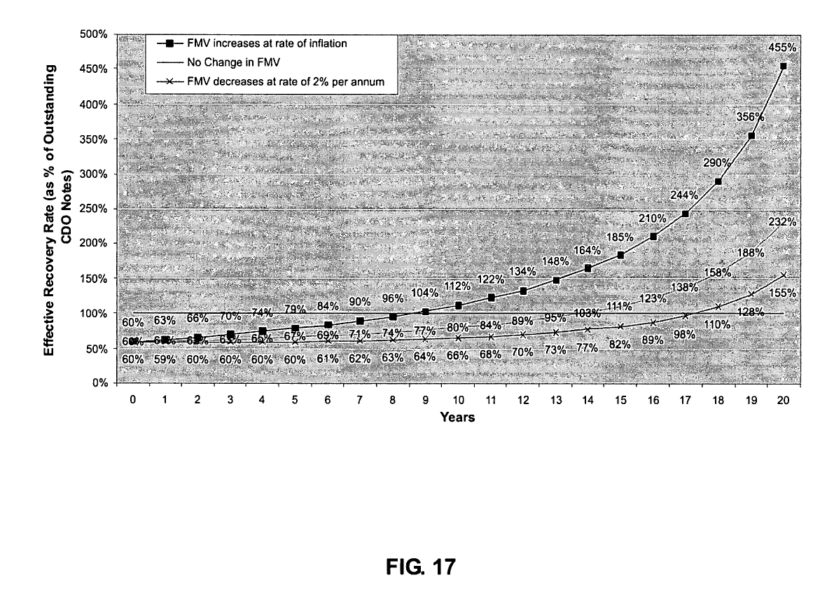

An overview of an exemplary capital structure, which can be modeled on a personal computer, is illustrated in FIG. 13. Exemplary terms for the net lease CDO are illustrated in FIGS. 14A-14C. An exemplary payment protocol is illustrated in FIGS. 15A and 15B. Exemplary portfolio limitations and coverage tests are illustrated in FIG. 16. An exemplary illustration of the effective recovery rate as a function of fair market value as a function of the percentage of outstanding CDO notes is illustrated in FIG. 17. As shown, the effective recovery rate increases i) as the CDO notes amortize, and ii) as the value of the properties increase. Given an exemplary recovery rate of, for example, 59%, the CDO notes can withstand 100% of the portfolio defaulting in years 9, 14, and 17 under various scenarios.

### Structural Features of the Net Lease CDO

The net lease CDO may have the following structural features:
(a) Subordination. The senior notes have, for example, 32.2% subordination from the senior subordinate notes and income notes. The senior subordinate notes have, for example, 5.4% subordination from the income notes.
(b) Optimal Principal Distribution Amount (OPDA). Starting on, for example, the sixth anniversary of the closing, in the event of collateral default, certain payments to the income note holders are immediately redirected to redeem the most senior class of notes outstanding. Notes will be redeemed in an amount equal to the principal amount of such defaulted collateral, subject to coverage payments made, available cash flow, and the terms of the indenture. Such redirection of excess interest into principal causes a deleveraging of the capital structure and creates additional subordination to the senior and senior subordinate notes. During years one through, for example, six, the coverage tests will govern as described below.
(c) Coverage Tests. Coverage Tests provide for the redirection of interest and principal cash flow to redeem the most senior notes in the event that any of the four coverage tests are not met. The early redemption of senior note principal results in increased equity subordination.
(d) Class B Accelerated Principal Repayment (“Turbo”). Starting on after, for example, year 1, 25% of the payments, for example, that would have been paid to the holders of the income notes will be redirected to pay down the principal balance of the Class B Notes. This shortens the average life of the Class B Notes and reduces the transaction's weighted average cost of capital.
(e) Reserve Account. The Reserve Account provides protection for interest shortfall of either the senior or senior subordinate notes and is a funded priority under the CDO's priority of payments.
(f) Recovery Rates. Due to a lack of historical default data, rating agencies take a worst-case position when evaluating these transactions. Thus, the ratings rely heavily on the nature and quality of the underlying collateral and the credit enhancements of the CDO structure.
   i. The assumed recovery rates on senior secured notes 40 employed by the rating agencies range from, for example, [40]% to [60]% depending on the particular rating agency, whereas, for traditional financial institution collateral backing pooled financial institution obligation CDOs, the assumed recovery rates employed by the rating agencies are generally 5% to 10%.
   ii. Moody's Diversity Score of the collateral is heavily penalized because all of the securities are of the same general industry sector. Studies conducted by the inventors and separately by the Federal Reserve and the various rating agencies illustrate the significance of geographic diversity with respect to regional banks, and the lack of correlation between issuers within the sector as a whole.

### Functions of the Collateral Manager

Initial credit selection, ongoing credit review and monitoring and disposing of securities is a key function of the collateral manager as discussed in more detail below.
Collateral Screening and Selection—Static securitizations transactions have a primary and troubling risk for investors . . . “Who is selecting the collateral and is it in my best interests?” Investment banks serving as underwriters for a securitization, while also serving as placement agent for collateral issuers, have a natural conflict in that their primary business is to raise capital for their investment banking clients. It may be in the best interest of an underwriter to include every issuer that wishes to come to market. It is this key issue that mandates the use of an independent collateral manager, to serve as the advocate for investors at the most important stage of the transaction . . . collateral accumulation. Note that this is a stage of the transaction where investors do not have any legal rights since the transaction has not yet closed.

Disposing of Collateral Debt Securities
While the historical default rates in the bank sector have been consistent with those experienced by Baa/BBB type corporate issuers, defaults are expected to occur not only in the bank sector, but within pooled transactions. Many pooled financial institution obligation CDOs are static pools, in which investors can only watch a stressed credit deteriorate. The net lease CDO collateral manager may (i) attempt to sell securities that are at risk for credit events and (ii) if net lease CDO collateral manager believes that the financial institution will not recover from an interruption in payments on the lease 38, attempt to either a) re-let the property 34 to another qualifying financial institution or b) sell the property 34 in order to achieve the highest possible recovery rate. In addition, the net lease CDO collateral manager may determine to liquidate the properties 34 that have appreciated in value before the respective lease terms expire. The CDO collateral manager may not reinvest into any new sale-leaseback transactions and will instead pass the proceeds of any sale through the net lease CDO's priority of payments.

Cash Flow Modeling and Reporting

Obviously, many modifications and variations of the present invention are possible in light of the above teachings. Thus, it is to be understood that, within the scope of the appended claims, the invention may be practiced otherwise than is specifically described above.

What is claimed and desired to be secured by a Letters Patent of the United States is:

1. A method of creating a collateralized debt obligation (CDO) comprising the steps of:
(a) acquiring a plurality of real properties for use by a plurality of financial institutions that have assets of less than $10 billion;
(b) leasing said plurality of real properties to a plurality of said financial institutions resulting in a plurality of leases, said real properties and said leases individually defining net lease assets;
(c) pooling said net lease assets; and
(d) funding the acquisition of said pool of net lease assets by selling at least one security collateralized by said net lease assets to one or more investors, wherein the investment rating of said security is not based on the explicit rating of any one of the individual financial institutions.

2. The method as recited in claim 1, wherein step (c) comprises pooling said net lease assets with traditional financial institution collateral; and step (d) comprises funding the acquisition of said net lease assets and said traditional financial institution collateral by selling securities collateralized by said net lease assets and said traditional financial institution collateral to one or more investors.

3. The method as recited in claim 2, wherein step (c) comprises: pooling said net lease assets with traditional financial institution collateral selected from the group of: other obligations of financial institutions; tranches of CDOs backed by obligations of financial institutions.

4. The method as recited in claim 1, wherein step (c) comprises pooling said net lease assets with traditional financial institution collateral and ABS, CMBS, CDOs, other real estate assets, residential mortgage backed securities (RMBS), corporate debt obligations or other debt securities or receivables and step (d) comprises funding the acquisition of said net lease assets and said traditional financial institution collateral and ABS, CMBS, CDOs, other real estate assets, residential mortgage backed securities (RMBS), corporate debt obligations or other debt securities or receivables by selling securities collateralized by said net lease assets and said traditional financial institution collateral and said other collateral to one or more investors.

5. The method as recited in claim 1, wherein step (d) comprises:
funding the acquisition of said plurality of real properties by selling at least one security to one or more third party investors backed by said real properties.

6. The method as recited in claim 1, wherein step (d) comprises funding the acquisition of said at least one real property by selling at least one security to a third party investor backed by lease payments.

7. The method as recited in claim 1, wherein steps (a) and (b) comprise:
acquiring at least one real property for use by an unrated financial institution and leasing said real property to an unrated financial institution.

8. The method as recited in claim 1, wherein step (a) comprises:
acquiring at least one real property for use by a rated financial institution.

9. The method as recited in claim 1, wherein step (a) comprises:
acquiring at least one real property for use by a bank.

10. The method as recited in claim 1, wherein step (a) comprises:
acquiring at least one real property for use by a thrift institution.

11. The method as recited in claim 1, wherein step (a) comprises:
acquiring at least one real property for use by an insurance company.

12. The method as recited in claim 1, wherein step (a) comprises:
acquiring at least one real property for use by a holding company of a financial institution.

13. The method as recited in claim 1, wherein steps (a) and (b) comprise:
creating a lease trust for purchasing said real property and leasing said real property to said financial institution.

14. The method as recited in claim 12, wherein step (d) includes creating a special purpose vehicle for acquiring a senior secured note from said lease trusts.

15. A method of creating an entity for purposes of satisfying the scheduled balloon payments on net lease assets that are not fully amortizing and that are included in a securitization, comprising the steps of:
(a) forming a bankruptcy remote entity for the purpose of acquiring the equity securities of the related lease trusts; and
(b) obligating such entity to pay to the securitization entity acquiring the related net lease assets an amount equal to the aggregate, scheduled, unamortized balance at maturity of the senior secured notes of the various lease trusts.
